(19) United States
(12) Patent Application Publication
(10) Pub. No.: US 2026/0289240 A1
(43) Pub. Date: Sep. 24, 2026

(54) ESTIMATION SYSTEM, ESTIMATION METHOD, AND INFORMATION STORAGE MEDIUM

(71) Applicants: Cybozu, Inc., Tokyo (JP); Cybozu Labs, Inc., Tokyo (JP)

(72) Inventors: Kota UCHIDA, Fujimino-shi (JP); Yohei YAMAGUCHI, Tokyo (JP)

(21) Appl. No.: 19/574,439

(22) Filed: Mar. 23, 2026

(30) Foreign Application Priority Data
Mar. 24, 2025 (JP) 2025-048898

(51) Int. Cl. G06N 3/0455; G06Q 10/40

(52) U.S. Cl. CPC G06N 3/0455; G06Q 10/40

(57) ABSTRACT

Provided is an estimation system including at least one processor configured to: acquire inquiry information relating to an inquiry input by a user; acquire profile information relating to a profile of each of a plurality of inquiry destinations; and cause an artificial intelligence (AI) which is a trained large language model to estimate an appropriate inquiry destination for the inquiry among the plurality of inquiry destinations based on the inquiry information and the profile information.

### CROSS-REFERENCE TO RELATED APPLICATION

The present disclosure contains subject matter related to that disclosed in Japanese Patent Application JP 2025-048898 filed in the Japan Patent Office on March 24, 2025, the entire contents of which are hereby incorporated by reference.

### BACKGROUND OF THE INVENTION

### 1. Field of the Invention

The present disclosure relates to an estimation system, an estimation method, and an information storage medium.

### 2. Description of the Related Art

Hitherto, there has been known a technology for supporting users who make an inquiry to an inquiry destination. For example, in "How to use the mention function and how to handle mentions," Internet, retrieved on February 26, 2025, online, https://www.microsoft.com/ja-jp/biz/smb/column-teams-mention, there is described a work support service in which users can exchange messages such as inquiries between each other. In the described work support service, when a user tries to mention another user by inputting a specific symbol (for example, @), an online chat displays a list of other users who are candidates as a mention destination, which is an example of the inquiry destination.

### SUMMARY OF THE INVENTION

However, in the technology of "How to use the mention function and how to handle mentions," other users who have been determined in advance are only displayed as candidates, and an appropriate candidate corresponding to the inquiry by the user is not displayed. As a result, in the technology of "How to use the mention function and how to handle mentions," the user is required to think of and select the appropriate candidate corresponding to his or her own inquiry, and for that reason, the technology of "How to use the mention function and how to handle mentions" has not been able to sufficiently increase convenience of the user.

One object of the present disclosure is to increase convenience of a user.

According to at least one aspect of the present disclosure, there is provided an estimation system including at least one processor configured to: acquire inquiry information relating to an inquiry input by a user; acquire profile information relating to a profile of each of a plurality of inquiry destinations; and cause an artificial intelligence (AI) which is a trained large language model to estimate an appropriate inquiry destination for the inquiry among the plurality of inquiry destinations based on the inquiry information and the profile information.

### BRIEF DESCRIPTION OF THE DRAWINGS

FIG. 1 is a diagram for illustrating an example of a hardware configuration of an estimation system.

FIG. 2 is a view for illustrating an example of a work support screen.

FIG. 3 is a diagram for illustrating an example of functions implemented in the estimation system.

FIG. 4 is a table for showing an example of a comment database.

FIG. 5 is a table for showing an example of a profile database.

FIG. 6 is a diagram for illustrating an example of inputs to an AI and an output from the AI.

FIG. 7 is a flow chart for illustrating an example of processing executed in the estimation system.

FIG. 8 is a diagram for illustrating an example of functions implemented in an estimation system according to modification examples.

FIG. 9 is a table for showing an example of a profile database in Modification Example 1.

FIG. 10 is a diagram for illustrating an example of inputs to an AI and an output from the AI in Modification Example 1.

FIG. 11 is a table for showing an example of profile databases in Modification Example 3.

FIG. 12 is a diagram for illustrating an example of inputs to an AI and an output from the AI in Modification Example 3.

FIG. 13 is a diagram for illustrating an example of inputs to an AI and an output from the AI in Modification Example 4.

FIG. 14 is a view for illustrating an example of a work support screen in Modification Example 5.

FIG. 15 is a view for illustrating an example of a work support screen in Modification Example 6.

FIG. 16 is a view for illustrating an example of a work support screen in Modification Example 7.

FIG. 17 is a view for illustrating an example of a work support screen in Modification Example 8.

FIG. 18 is a diagram for illustrating an example of inputs to an AI and an output from the AI in Modification Example 9.

### DESCRIPTION OF THE EMBODIMENTS

### 1. Hardware Configuration

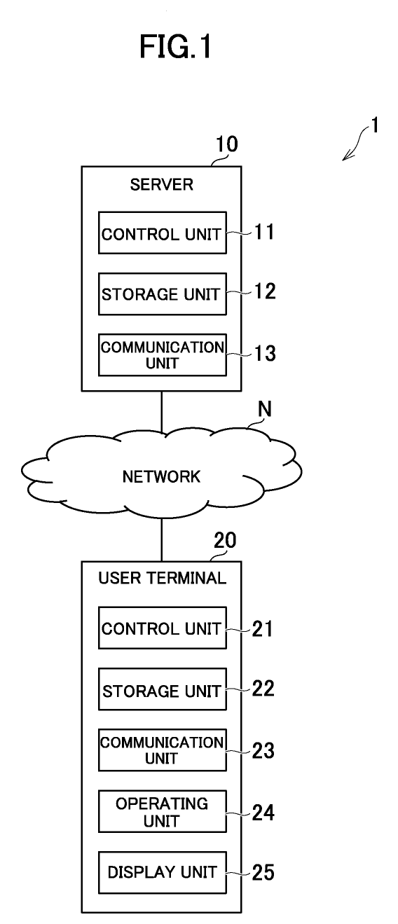

An example of an estimation system, an estimation method, and a program according to at least one embodiment of the present disclosure is described. FIG. 1 is a diagram for illustrating an example of a hardware configuration of the estimation system. For example, an estimation system 1 includes a server 10 and a user terminal 20. The server 10 and the user terminal 20 are each connected to a network N such as the Internet or a LAN. In FIG. 1, a single server 10 and a single terminal 20 is illustrated, but there may be a plurality of at least one of the server 10 or the user terminal 20.

The server 10 is a server computer. For example, the server 10 includes a control unit 11, a storage unit 12, and a communication unit 13. The control unit 11 includes at least one processor. The storage unit 12 includes at least one of a volatile memory such as a RAM, or a non-volatile memory such as a flash memory. The communication unit 13 includes at least one of a communication interface for wired communication or a communication interface for wireless communication.

The user terminal 20 is a computer of a user. For example, the user terminal 20 is a personal computer, a tablet terminal, a smartphone, or a wearable terminal. For example, the user terminal 20 includes a control unit 21, a storage unit 22, a communication unit 23, an operating unit 24, and a display unit 25. Hardware configurations of the control unit 21, the storage unit 22, and the communication unit 23 may be the same as those of the control unit 11, the storage unit 12, and the communication unit 13, respectively. The operating unit 24 is an input device such as a mouse or a touch panel. The display unit 25 is a liquid crystal display or an organic EL display.

Programs stored in the storage units 12 and 22 may be supplied via the network N. A hardware configuration of each of the server 10 and the user terminal 20 is not limited to the example of FIG. 1. For example, at least one of the server 10 or the user terminal 20 may include at least one of a reading unit (for example, a memory card slot) that reads a computer-readable information storage medium or an input/output unit (for example, a USB terminal) for directly connecting to an external device. A program stored in the information storage medium may be supplied to at least one of the server 10 or the user terminal 20 through at least one of the reading unit or the input/output unit.

Moreover, the estimation system 1 is only required to include at least one computer. The computers included in the estimation system 1 are not limited to the example of FIG. 1. For example, the estimation system 1 may include only the server 10. In this case, the user terminal 20 is present outside the estimation system 1. The estimation system 1 may include the server 10 and another computer which is not shown in FIG. 1.

### 2 Overview of Estimation System

In the at least one embodiment, a case in which the estimation system 1 is applied to a work support service is taken as an example. The work support service is a service that supports work of the user. The work support service may be a service called groupware, or may be a service that is not classified as groupware in particular. The work support service may be a cloud-based service, or may be an on-premises service. For example, when the user logs in to the work support service, the user terminal 20 displays on the display unit 25 a work support screen for supporting the work of the user.

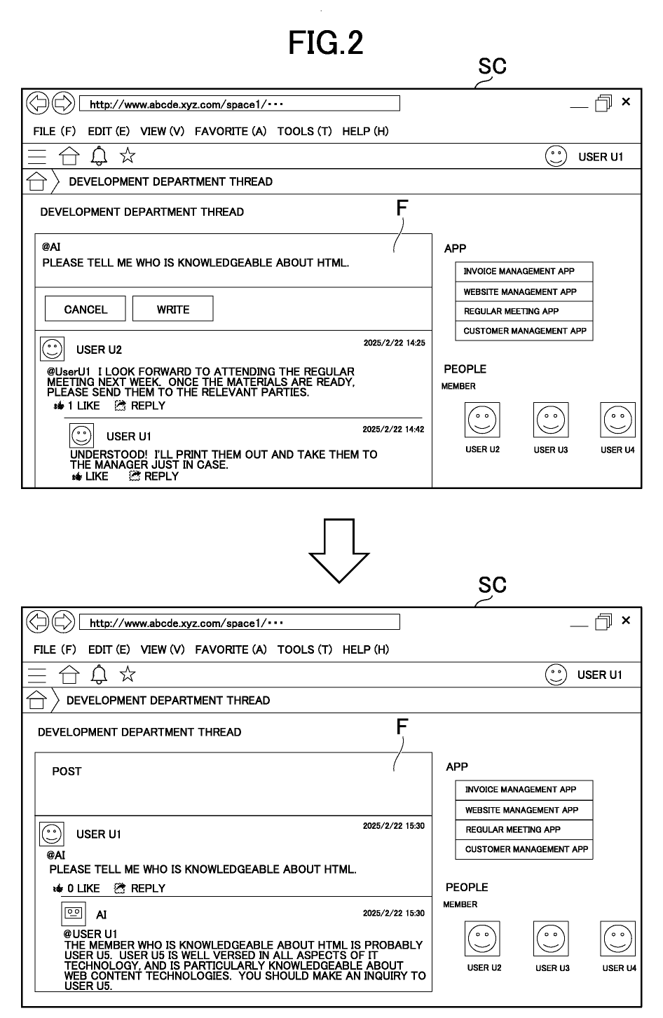

FIG. 2 is a view for illustrating an example of the work support screen. In FIG. 2, there is illustrated an example of a work support screen SC of a communication function for users to communicate with each other. For example, as illustrated in the upper part of FIG. 2, the work support screen SC shows the contents of a thread in which various comments have been posted. The user communicates with other users by inputting a new comment into an input form F or replying to a comment by another user. The user may communicate with other users who belong to an organization (for example, company) to which the user belongs, or may communicate with other users outside the organization.

In the at least one embodiment, a case in which the user makes an inquiry relating to his or her own work as a comment posted to a thread is taken as an example. For example, there may be a case in which a user working on web content wants to know information about HTML. In this case, the user inputs an inquiry relating to HTML in order to acquire information about HTML from another user. However, when the user does not know which other user is knowledgeable about HTML, the user may not know an appropriate inquiry destination.

Thus, in the at least one embodiment, an artificial intelligence (AI) estimates the appropriate inquiry destination for the inquiry input by the user. Details of the AI are described later. In the example of the upper part of FIG. 2, the user mentions the AI, for example, by inputting "@AI," and then inputs an inquiry such as "Please tell me who is knowledgeable about HTML." After inputting the inquiry text, the user can complete input of the inquiry by performing a predetermined operation (for example, selecting a user interface part to indicate completion of input, or pressing a predetermined key). The inquiry relates to HTML, and hence the appropriate inquiry destination is another user who is knowledgeable about HTML. The AI estimates the another user who is knowledgeable about HTML as the appropriate inquiry destination. Details of the processing by which the AI estimates the appropriate inquiry destination are described later.

For example, when the AI estimates the appropriate inquiry destination, the user terminal 20 displays the appropriate inquiry destination estimated by the AI on the work support screen SC, as illustrated in the lower part of FIG. 2. In the example of the lower part of FIG. 2, the appropriate inquiry destination estimated by the AI is shown in an answer comment from the AI. For example, the AI estimates the another user who is knowledgeable about HTML based on comments posted to the thread in the past. The user refers to the answer from the AI, mentions the another user who is knowledgeable about HTML, and makes an inquiry relating to HTML.

As described above, in the estimation system 1 according to the at least one embodiment, the AI estimates the appropriate inquiry destination for the inquiry input by the user. The estimation system 1 displays the appropriate inquiry destination estimated by the AI on the work support screen SC. As a result, the user can know the appropriate inquiry destination to respond to the inquiry by the user. The user is not required to look up the appropriate inquiry destination by himself or herself, and hence the estimation system 1 can increase the convenience of the user. Details of the estimation system 1 are described below.

### 3 Functions Implemented in Estimation System

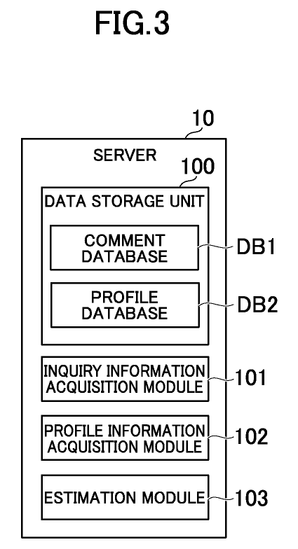

FIG. 3 is a diagram for illustrating an example of functions implemented in the estimation system 1. In FIG. 3, functions implemented in the server 10 among the functions implemented in the estimation system 1 are illustrated. For example, the server 10 includes a data storage unit 100, an inquiry information acquisition module 101, a profile information acquisition module 102, and an estimation module 103. The data storage unit 100 is implemented by the storage unit 12. Each of the inquiry information acquisition module 101, the profile information acquisition module 102, and the estimation module 103 is implemented by the control unit 11.

### Data Storage Unit

The data storage unit 100 stores data required for supporting work. For example, the data storage unit 100 stores a comment database DB1 and a profile database DB2.

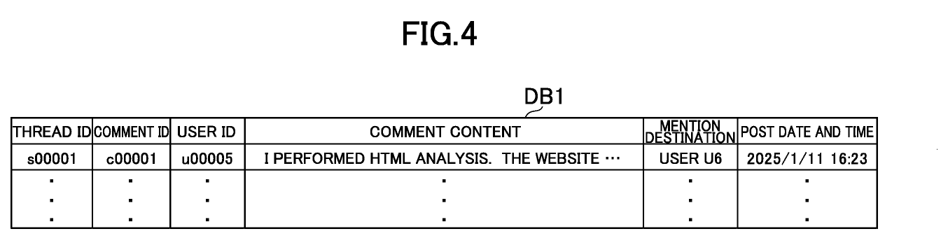

FIG. 4 is a table for showing an example of the comment database DB1. The comment database DB1 is a database which stores various kinds of information on comments posted in the work support service. For example, the comment database DB1 stores a thread ID that can identify a thread, a comment ID that can identify a comment, a user ID of the user who posted the comment, the content of the comment (for example, characters, numerals, other symbols, attached files, or a combination thereof), information on a mention destination in the comment, and a post date and time. The information stored in the comment database DB1 is not limited to the example of FIG. 4. Any information relating to a comment may be stored in the comment database DB1.

For example, when the user creates a new thread, the server 10 issues a thread ID for that thread. When a new comment is posted to the thread, the server 10 issues a comment ID for the new comment. The server 10 stores the user ID of the user who has posted the new comment, the content of the new comment, information on the mention destination in the new comment, and the post date and time in association with the thread ID and the comment ID in the comment database DB1. Similarly, when an answer from the AI is input as a comment, the server 10 stores information such as the comment ID of the comment from the AI in the comment database DB1.

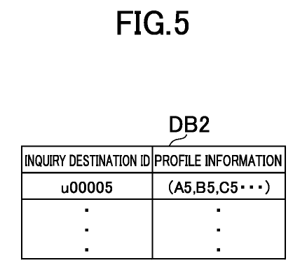

FIG. 5 is a table for showing an example of the profile database DB2. The profile database DB2 is a database which stores profile information on each of a plurality of inquiry destinations. For example, the profile database DB2 stores an inquiry destination ID that can identify the inquiry destination and the profile information. Any data may be stored in the profile database DB2. The data stored in the profile database DB2 is not limited to the example of FIG. 5. For example, the profile database DB2 may store information to serve as an index at the time of search in retrieval-augmented generation (RAG) (for example, a keyword indicating a characteristic of the profile information, department name, team name, project name, job title, or work location), the name of the inquiry destination (for example, the name of the user), or the date and time the profile information is created.

The profile of the inquiry destination is a characteristic or an attribute of the inquiry destination. Profile information is information which indicates the profile of the inquiry destination. The profile information may be in any format. For example, the profile information may be characters, numerals, other symbols, or a combination thereof. The profile information may indicate areas in which the inquiry destination is knowledgeable or skilled. The profile information may also indicate the content of inquiries that the inquiry destination can handle.

In the at least one embodiment, each of the plurality of users who use the work support service can become the inquiry destination, and hence the inquiry destination ID is the user ID. The profile of the inquiry destination is the profile of the user. The profile information indicates a profile of the user. That is, the profile information is a characteristic or an attribute of the user. For example, the profile information may indicate the content of the work the user is responsible for, the areas in which the user is knowledgeable or skilled, the number of years the user has been employed, a career path of the user, demographic information on the user, a self-introduction input by the user, or a combination of those.

For example, the server 10 generates profile information based on the comment database DB1, and stores the generated profile information in the profile database DB2. For each user, the server 10 acquires comments posted by the user from the comment database DB1, and generates the profile information for the user based on those comments. The server 10 may directly use the comments posted by the user as the profile information for the user, or the server 10 may vectorize the comments posted by the user and use the generated vector as the profile information for the user. In the example of FIG. 5, there is shown a case in which the profile information is in a vector format.

The vector is information indicating characteristics of the words. The vectorization may be performed by using a publicly-known method used in the field of natural language processing. For example, the server 10 may vectorize the comments based on Doc2Vec, FastText, a transformer-based model, or another method. The server 10 may generate one vector from a plurality of comments posted by the user, or may generate a vector for each individual comment. The server 10 may generate a vector by selecting only some of the plurality of comments posted by the user.

The profile information may indicate not only the content of the profile but also which inquiry destination the profile belongs to. For example, when the inquiry destination is another user, the profile information may indicate information indicating who the another user is (for example, the name of the another user or the user ID of the another user) and the specific content of the profile (for example, information in a vector format).

The data stored in the data storage unit 100 is not limited to the above-mentioned example. The data storage unit 100 can store any data. In the at least one embodiment, a case in which the AI is managed by an external system outside the estimation system 1 is taken as an example, but when the estimation system 1 manages the AI, the data storage unit 100 may store the actual data of the AI. That is, when the estimation system 1 uses the AI in a local environment in which communication to and from an external system does not occur, the data storage unit 100 may store the actual data of the AI.

In the at least one embodiment, a case in which the AI corresponds to a pre-trained large language model is taken as an example. The large language model may be of any type. For example, the large language model may be a transformer-based model such as a generative pre-trained transformer (GPT) or bidirectional encoder representations from transformers (BERT), or another model not classified as a transformer (for example, a neural network). The AI may be an AI created for the estimation system 1, but in the at least one embodiment, the AI is a publicly-known AI.

For example, the AI includes a program that indicates a series of processes from when input information, which is information input to the AI, is input until output is performed, and parameters to be referred to by the program. The parameters of the AI may be incorporated into a part of the program of the AI. The parameters of the AI may be similar to publicly-known parameters. For example, the parameters of the AI may be weights and biases. The AI may include other information other than the program and the parameters. The AI may be a single-modal type AI that can process only input information which is in a specific format, or may be a multi-modal type AI that can process input information which is in a plurality of formats.

For example, the AI may include an input layer that processes the input information, an intermediate layer that calculates an embedded representation of the input information based on the parameters, and an output layer that performs output corresponding to the embedded representation. The embedded representation is information for the AI to recognize the input information. The embedded representation may also be called a feature amount or a feature vector. The embedded representation may be a multidimensional vector, or may be in another form (for example, an array, a matrix, a single numerical value, or a plurality of numerical values). The input information may be divided into units called tokens. The AI may calculate embedded representations for individual tokens. The AI may predict the continuation of the input information based on a sequential order of the embedded representations of the individual tokens.

In the at least one embodiment, the AI is assumed to have already learned various kinds of training data. When a model capable of natural language processing, which is exemplified by the large language model, corresponds to the AI, the AI is assumed to have already learned various kinds of text for training as the training data. The parameters of the AI have been adjusted by learning the training data. A general-purpose AI that has been subjected to pre-training may be used as it is, or an AI that has been fine-tuned for the estimation system 1 may be used. The learning method for the AI may be similar to a publicly-known machine learning method. As with the definitions of the AI, there are various views in terms of definitions of the machine learning, but the machine learning in the at least one embodiment includes various publicly-known definitions. For example, deep learning is also included in the machine learning.

For example, the data storage unit 100 may store a default prompt to be input to the AI. The default prompt is a prompt prepared in advance. The data storage unit 100 may store data of a screen to be displayed on the user terminal 20. The data storage unit 100 may store a user database in which various kinds of information (for example, email address to which a mention is to be sent) on each of the plurality of users in the work support service are stored. The data storage unit 100 may also store a database in which various kinds of information on notifications in the work support service (for example, notifications received by users who have been mentioned) are stored.

### Inquiry Information Acquisition Module

The inquiry information acquisition module 101 acquires inquiry information relating to an inquiry input by the user. An inquiry is a question requiring an answer. The inquiry information is information indicating the content of an inquiry input by the user. For example, the inquiry information may be characters, numerals, other symbols, files such as documents or images, or a combination of those. For example, the user may input the inquiry from the operating unit 24, or may input the inquiry by voice input or data input to the user terminal 20.

In the at least one embodiment, the estimation system 1 is applied to a work support service, and hence the inquiry information acquisition module 101 acquires inquiry information when a user using the work support service inputs an inquiry relating to work. An inquiry relating to work is an inquiry relating to the content of the work to be supported by the work support service. For example, the inquiry relating to work may relate to how to proceed with the work, basic knowledge required for the work, information on the organization to which the user belongs, information on an external organization related to the work, or another inquiry.

In the example of FIG. 2, the user inputs an inquiry into the input form F of the work support screen SC. The user terminal 20 transmits inquiry information relating to the inquiry input by the user to the server 10. The inquiry information acquisition module 101 acquires the inquiry information from the user terminal 20. The inquiry information acquisition module 101 may acquire the inquiry information from another computer other than the user terminal 20. For example, when another computer which accumulates inquiry information is present, the inquiry information acquisition module 101 may acquire the inquiry information from the another computer.

The screen on which the user inputs the inquiry is not limited to the work support screen SC. The user may input the inquiry from another screen other than the work support screen SC. For example, the user may input the inquiry from a bulletin board not classified as conversation threading, an online chat, a comment field of a database function, a comment field of an email sharing function, a comment field of a schedule management function, a screen of another work support function, or from another screen. The inquiry information acquisition module 101 may acquire the inquiry information relating to the inquiry input by the user on those screens.

The user may input the inquiry in another work support function other than the communication function in the work support service. For example, the user may input the inquiry in a schedule management function for managing a schedule, a database function for managing data, or an email management function for managing emails. The inquiry information acquisition module 101 may acquire the inquiry information relating to the inquiry input by the user in the another work support function.

### Profile Information Acquisition Module

The profile information acquisition module 102 acquires profile information relating to the profile of each of a plurality of inquiry destinations. The inquiry destinations are the destination to which the inquiry by the user is sent. For example, the inquiry destinations may be a user who answers an inquiry by the user (for example, another user, organization, department, or team), a communication place in which communication takes place (for example, a thread, a bulletin board not classified as conversation threading, an online chat room, a space, or a channel), or the destination to which the inquiry by the user is sent (for example, an email address, a messaging app account, or a phone number).

In the at least one embodiment, the profile information is stored in the profile database DB2, and hence the profile information acquisition module 102 acquires the profile information on each of the plurality of inquiry destinations from the profile database DB2. The profile information acquisition module 102 may acquire all of the profile information stored in the profile database DB2. The profile information acquisition module 102 may randomly acquire a part of the profile information from the profile database DB2. The profile information may be stored in another database other than the profile database DB2, another computer other than the server 10, or an information storage medium. The profile information acquisition module 102 may acquire the profile information from the another database, the another computer, or the information storage medium.

In the at least one embodiment, a case in which the profile information acquisition module 102 acquires at least one piece of profile information by using a RAG mechanism to search the profile database DB2 is taken as an example. For example, the profile information acquisition module 102 searches the profile database DB2 based on the inquiry information. The search method may be the same as a publicly-known method.

For example, the profile information acquisition module 102 may acquire at least one piece of profile information by vectorizing the inquiry information and searching the profile database DB2 based on the vector of the inquiry information. In this case, the profile information acquisition module 102 acquires profile information which is relatively close to the vector of the inquiry information in the vector space.

For example, the profile information acquisition module 102 may acquire keywords from the inquiry information and search the profile database DB2 based on the keywords. The method of acquiring the keywords may also be the same as a publicly-known method. For example, the profile information acquisition module 102 may acquire keywords by performing morphological analysis on the inquiry information. When keywords are used, it is assumed that keywords to serve as an index for the search have been associated with the profile information in advance.

In the at least one embodiment, the estimation system 1 is applied to a work support service, and hence the profile information acquisition module 102 acquires profile information which is based on the work support service. The profile information based on the work support service is profile information created based on data registered in the work support service. For example, profile information created based on comment data stored in the comment database DB1 corresponds to profile information based on the work support service.

The profile information based on the work support service may be created based on data stored in another database other than the comment database DB1. For example, the profile information based on the work support service may be created based on a database which stores posts registered on a bulletin board not classified as conversation threading, an online chat, or another communication tool.

For example, the profile information based on the work support service may be created based on a database managed by a database function. The profile information based on the work support service may be created based on a database of schedules registered in a schedule management function. The profile information based on the work support service may be created based on a database of shared emails registered in a shared email function.

In the at least one embodiment, a case in which the plurality of inquiry destinations are a plurality of other users different from the user is taken as an example. For this purpose, the profile information acquisition module 102 acquires profile information relating to the profile of each of the plurality of other users. The profile information indicates characteristics or attributes of the other users. For example, the profile information may indicate the content of the work each of the other users is responsible for, or the areas in which each of the other users is knowledgeable or skilled.

The profile information may be generated based on information registered in another service other than the work support service. For example, when the work support service is linked to a social networking service (SNS), the profile information may be generated based on posts in the SNS by various users who use the work support service. The profile information acquisition module 102 may acquire the profile information generated based on information registered in the another service.

Further, the profile information acquisition module 102 can acquire the profile information at any timing. For example, the profile information acquisition module 102 acquires the profile information when the estimation by the AI is executed. The profile information is not required to be generated in advance, and may be generated at the same time the estimation by the AI is executed. The profile information may be generated in advance and then adjusted by an administrator. The profile information is not required to be generated based on comments, and information registered in the work support service (for example, employee lists, personnel documents, or evaluation information) may be directly used as it is.

Further, the profile information acquisition module 102 may acquire the profile information before the user inputs the inquiry. The server 10 may train the AI through use of the profile information acquired by the profile information acquisition module 102 in advance. For example, based on the profile information, the server 10 may retrain (for example, fine-tune) an AI that has been trained through use of documents other than the profile information as training data. That is, the server 10 may make small adjustments to the parameters of the AI based on the profile information. The AI retraining processing may be executed by the estimation module 103 described below.

### Estimation Module

The estimation module 103 causes the AI, which is a trained large language model, to estimate an appropriate inquiry destination for the inquiry among the plurality of inquiry destinations based on the inquiry information and the profile information. For example, the estimation module 103 inputs the inquiry information and the profile information to the AI as input information. The estimation module 103 may combine the inquiry information and the profile information and input the combined information to the AI, or may input the inquiry information and the profile information separately to the AI without combining the inquiry information and the profile information.

In the at least one embodiment, a case in which the AI is managed by an external system is taken as an example, and hence the estimation module 103 inputs the inquiry information and the profile information to the AI by transmitting the inquiry information and the profile information to the external system. The estimation module 103 acquires, from the external system, information indicating the appropriate inquiry destination estimated by the AI. When the AI is stored in the data storage unit 100, the estimation module 103 may input the inquiry information and the profile information to the AI stored in the data storage unit 100. The estimation module 103 may acquire the information indicating the appropriate inquiry destination output from the AI stored in the data storage unit 100.

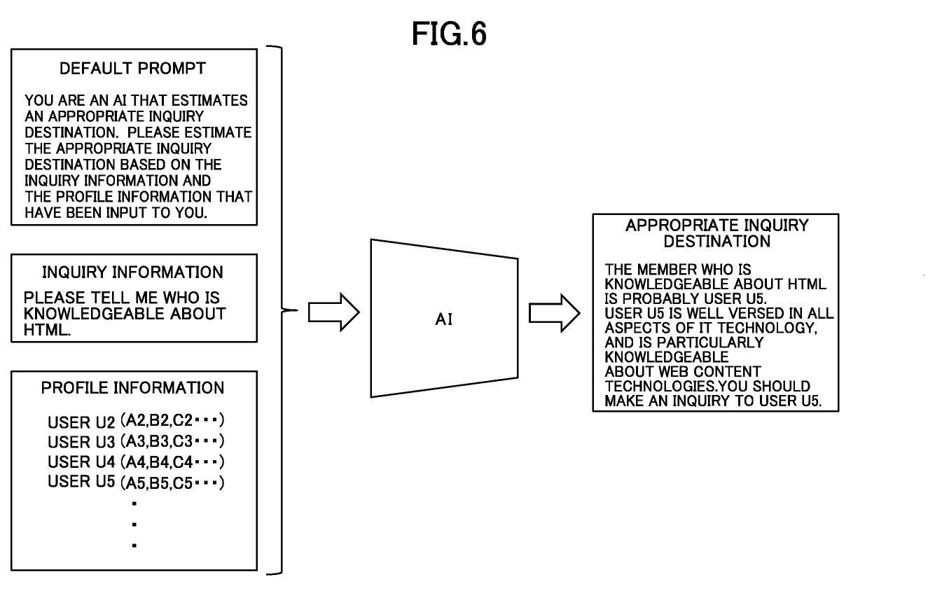

FIG. 6 is a diagram for illustrating an example of inputs to the AI and an output from the AI. In the at least one embodiment, the estimation module 103 inputs a default prompt, the inquiry information, and the profile information to the AI as input information. The default prompt indicates the task of the AI. In other words, the default prompt indicates what kind of product the AI is to output based on the input information. The default prompt is written in natural language. At least one of the inquiry information or the profile information may be incorporated into the default prompt. The default prompt may indicate what kind of information each of the inquiry information and the profile information is. Instead of the default prompt, a prompt input by the user may be input to the AI.

For example, the default prompt includes a sentence in natural language indicating that an appropriate inquiry destination is to be estimated based on inquiry information and profile information. The default prompt may be prepared by an administrator of the estimation system 1 or an administrator of the organization to which the user belongs. In the example of FIG. 6, the default prompt indicates a sentence such as "You are an AI that estimates an appropriate inquiry destination. Please estimate the appropriate inquiry destination based on the inquiry information and the profile information that have been input to you." The default prompt may be any sentence. The default prompt is not limited to the example of FIG. 6.

For example, when the default prompt, the inquiry information, and the profile information are input to the AI, the AI calculates an embedded representation of the default prompt, the inquiry information, and the profile information based on pre-adjusted parameters. The AI may divide the default prompt, the inquiry information, and the profile information into units called tokens, and calculate an embedded representation for each token. The AI outputs information indicating the appropriate inquiry destination corresponding to the embedded representations. The AI can estimate the appropriate inquiry destination corresponding to the inquiry information and the profile information after having predicted the next sentence as required based on the embedded representation of the default prompt. The estimation module 103 acquires the information indicating the appropriate inquiry destination output from the AI.

In the example of FIG. 6, the profile information indicates the names of other users and the profiles of those other users. For example, the AI estimates that a user U5 is the appropriate inquiry destination by predicting the next sentence as required based on the embedded representation of the default prompt, the inquiry information, and the profile information. The AI outputs a sentence indicating that the user U5 is the appropriate inquiry destination. The estimation module 103 acquires the sentence output by the AI. The estimation module 103 transmits the data of the sentence output from the AI to the user terminal 20. As illustrated in the lower part of FIG. 2, the user terminal 20 displays the sentence on the work support screen SC.

In the at least one embodiment, the inquiry information and the profile information are pieces of information relating to the work support service, and hence the estimation module 103 causes the AI to estimate the appropriate inquiry destination in the work support service. The appropriate inquiry destination in the work support service may be a user who uses the work support service, an organization, a department, a team, a communication place (for example, a thread, a bulletin board not classified as conversation threading, an online chat room, a space, or a channel), an email address, or other information. The AI estimates the appropriate inquiry destination in the work support service as the appropriate inquiry destination corresponding to the embedded representation.

In the at least one embodiment, the estimation module 103 causes the AI to estimate, among the plurality of other users, another user who is appropriate for the inquiry as the appropriate inquiry destination. The plurality of other users forming the population may belong to the same organization as the organization to which the user belongs, or may be people who do not have a relationship in particular with the organization to which the user belongs. The AI estimates at least one other user. When an appropriate another user does not exist, the AI may output information indicating that an appropriate another user has not been estimated. The AI estimates the appropriate another user corresponding to the embedded representation.

For example, when the profile information is generated for each department, the AI estimates a department as the appropriate inquiry destination. The estimation module 103 transmits data indicating the department estimated by the AI to the user terminal 20. The user terminal 20 displays the department, instead of a specific individual, as the appropriate inquiry destination on the work support screen SC. When the profile information is generated for each communication place (for example, thread), the AI estimates a place as the appropriate inquiry destination. The estimation module 103 transmits data indicating the communication place estimated by the AI to the user terminal 20. The user terminal 20 displays the communication place, instead of a specific individual, as the appropriate inquiry destination on the work support screen SC.

In the at least one embodiment, a case in which the estimation module 103 executes the estimation when the user mentions the AI, for example, by inputting "@AI," is taken as an example. For example, when the user has completed input of the inquiry, the estimation module 103 determines whether or not the inquiry information contains a specific character string such as "@AI." The specific character string is a character string indicating that the AI is mentioned. When the estimation module 103 does not determine that the inquiry information contains the specific character string, the estimation module 103 does not execute the estimation by the AI. When the estimation module 103 determines that the inquiry information contains the specific character string, the estimation module 103 executes the estimation by the AI.

The estimation module 103 may execute the estimation by the AI even when the user does not mention the AI in particular. For example, when a user interface part for requesting estimation by AI is displayed on the work support screen SC, the estimation module 103 may execute the estimation by the AI when the part is selected. The estimation module 103 may execute the estimation by the AI without receiving an explicit instruction from the user. For example, the estimation module 103 may execute the estimation by the AI when the user inputs some kind of inquiry without in particular mentioning the AI.

### 4 Processing Executed in Estimation System

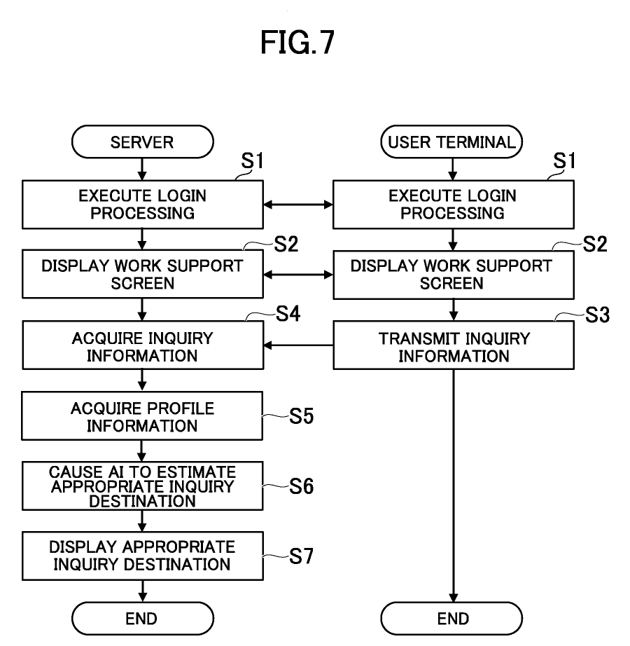

FIG. 7 is a flow chart for illustrating an example of processing executed in the estimation system 1. The processing of FIG. 7 is executed by the control units 11 and 21 executing the programs stored in the storage units 12 and 22, respectively. It is assumed that when the processing of FIG. 7 is executed, the server 10 generates the profile information based on the comment database DB1.

As illustrated in FIG. 7, the server 10 executes, between the server 10 and the user terminal 20, login processing for the user to log in to the work support service (Step S1). When the user selects any thread in the work support service, the server 10 executes, between the server 10 and the user terminal 20, processing for displaying the work support screen SC showing the thread selected by the user (Step S2). The processing that is executed when the user mentions the AI from the work support screen SC to cause the AI to estimate an inquiry destination is now described.

The user terminal 20 transmits inquiry information to the server 10 based on the input to the input form F (Step S3). The server 10 acquires the inquiry information from the user terminal 20 (Step S4). The server 10 acquires profile information from the profile database DB2 (Step S5). In Step S5, the server 10 vectorizes the inquiry information and retrieves the profile information. The server 10 may acquire the profile information from the profile database DB2 without in particular using a RAG mechanism.

The server 10 causes the AI to estimate an appropriate inquiry destination based on the inquiry information acquired in Step S4 and the profile information acquired in Step S5 (Step S6). In Step S6, the server 10 inputs the inquiry information and the profile information to the AI together with the default prompt stored in the storage unit 12. The server 10 acquires information indicating the appropriate inquiry destination output from the AI. The server 10 executes, between the server 10 and the user terminal 20, processing for displaying the appropriate inquiry destination estimated by the AI on the work support screen SC (Step S7), and the process ends. In Step S7, the server 10 displays the appropriate inquiry destination estimated by the AI on the work support screen SC.

### 5 Summary of at Least One Embodiment

The estimation system 1 according to the at least one embodiment acquires inquiry information. The estimation system 1 acquires profile information on each of a plurality of inquiry destinations. The estimation system 1 causes an AI to estimate an appropriate inquiry destination for the inquiry among the plurality of inquiry destinations based on the inquiry information and the profile information. As a result, the user can know the appropriate inquiry destination for responding to his or her own inquiry. The user is not required to search for the appropriate inquiry destination by himself or herself, and hence the estimation system 1 can increase the convenience of the user.

Further, the estimation system 1 acquires the inquiry information when the user who is using a work support service inputs an inquiry relating to work. The estimation system 1 acquires the profile information based on the work support service. The estimation system 1 causes the AI to estimate the appropriate inquiry destination in the work support service. As a result, the user can know the appropriate inquiry destination for responding to the inquiry relating to his or her own work. The user is not required to search for the appropriate inquiry destination by himself or herself, and hence the estimation system 1 can increase the convenience of the user.

Further, the plurality of inquiry destinations are a plurality of other users different from the user. The estimation system 1 acquires the profile information relating to the profile of each of the plurality of other users. The estimation system 1 causes the AI to estimate, among the plurality of other users, another user who is appropriate for the inquiry as the appropriate inquiry destination. As a result, the user can know the appropriate another user for responding to his or her own inquiry. The user is not required to search for the appropriate another user by himself or herself, and hence the estimation system 1 can increase the convenience of the user.

### 6 Modification Examples

The present disclosure is not limited to the at least one embodiment described above. The present disclosure can be modified as required without departing from the purport of the present disclosure.

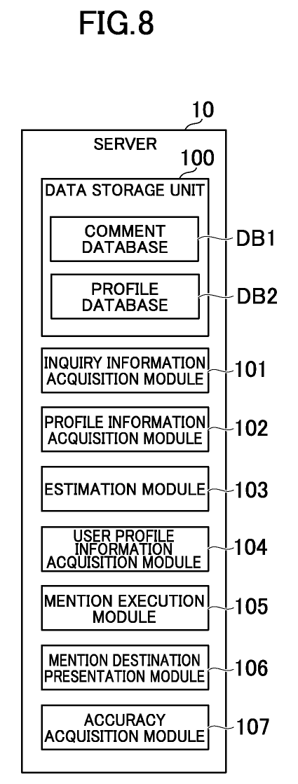

FIG. 8 is a diagram for illustrating an example of functions implemented in the estimation system 1 according to modification examples. As illustrated in FIG. 8, in the modification examples described below, in the server 10, a user profile information acquisition module 104, a mention execution module 105, a mention destination presentation module 106, and an accuracy acquisition module 107 are implemented. Each of the user profile information acquisition module 104, the mention execution module 105, the mention destination presentation module 106, and the accuracy acquisition module 107 is implemented by the control unit 11.

### 6-1. Modification Example 1

For example, the profile of a certain inquiry destination may change over time. When the inquiry destination is another user, the work that the another user is responsible for may change over time. The work that the another user is knowledgeable about or skilled at may also change over time. The same applies when the inquiry destination is another destination other than another user (for example, an organization, a department, a team, a thread, a bulletin board not classified as conversation threading, or an online chat room). Thus, in Modification Example 1, a case in which profile information is prepared for each period is described.

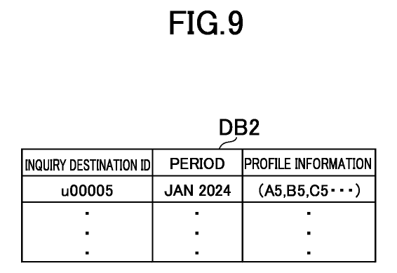

FIG. 9 is a table for showing an example of the profile database DB2 in Modification Example 1. As shown in FIG. 9, in the profile database DB2 in Modification Example 1, an inquiry destination ID, a period, and profile information are stored in association with each other. That is, profile information is associated with the inquiry destination ID of a certain inquiry destination for each period. The period may be of any length. In Modification Example 1, a case in which the period is one month is taken as an example, but the period may be shorter or longer than one month. For example, the period may be a day, a week, a quarter, or a year.

For example, the server 10 generates, based on the comment database DB1, profile information for a certain period from comments posted in that period, and stores the generated profile information in the profile database DB2. In Modification Example 1, the period is one month, and hence for each month, the server 10 generates, from the comments posted by another user in that month, profile information on the another user for that month and stores the generated profile information in the profile database DB2. The server 10 may store profile information for all past periods in the profile database DB2, or may store profile information for the most recent periods (for example, each month of the most recent year) in the profile database DB2. For one period, there is profile information for each of a plurality of inquiry destinations.

The profile information acquisition module 102 in Modification Example 1 acquires the profile information relating to the profile of each of the plurality of inquiry destinations for each of a plurality of periods. The profile information acquisition module 102 may acquire the profile information on each of the plurality of inquiry destinations for all periods, or may acquire the profile information on each of the plurality of inquiry destinations for some periods. For example, the profile information acquisition module 102 acquires the profile information for each month in the most recent year from the profile database DB2. The profile information acquisition module 102 may acquire the profile information for each month in the most recent year from another database, another computer other than the server 10, or an information storage medium.

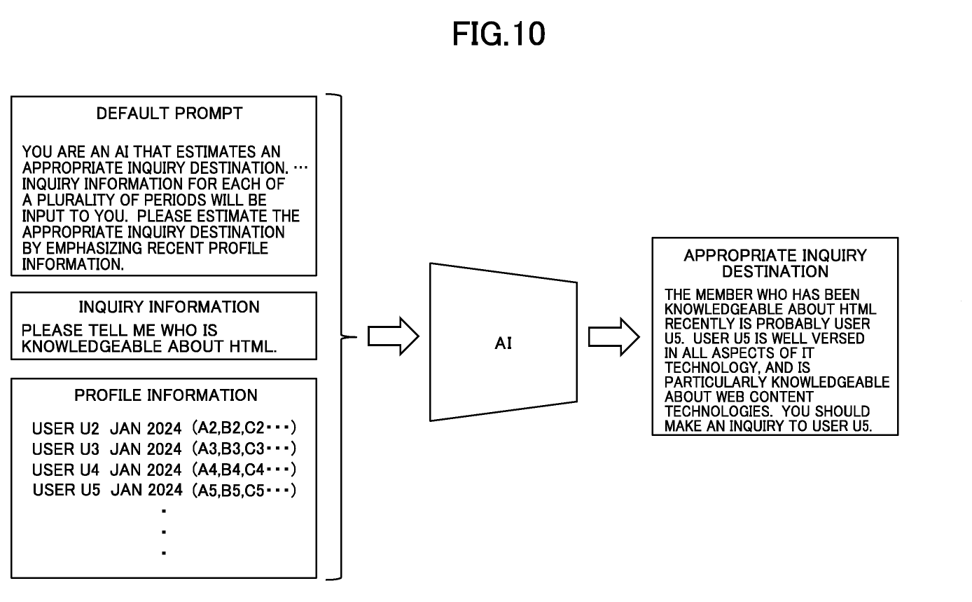

FIG. 10 is a diagram for illustrating an example of inputs to the AI and an output from the AI in Modification Example 1. As illustrated in FIG. 10, the default prompt in Modification Example 1 indicates that the inquiry destination is to be estimated by emphasizing recent profile information. For example, the default prompt indicates a sentence such as "Inquiry information for each of a plurality of periods will be input to you. Please estimate the appropriate inquiry destination by emphasizing recent profile information." The default prompt may be another sentence. For example, the default prompt may indicate that the inquiry destination is to be estimated by emphasizing older profile information, or that the inquiry destination is to be estimated by emphasizing profile information at or near a specific date and time. The specific date and time may be designated by the user.

The estimation module 103 in Modification Example 1 causes the AI to estimate the appropriate inquiry destination based on the profile information relating to the profile of each of the plurality of inquiry destinations for each of the plurality of periods. For example, the estimation module 103 inputs the default prompt of FIG. 10, the inquiry information, and the profile information on each of the plurality of inquiry destinations for each of the plurality of periods to the AI. The AI calculates an embedded representation of those inputs based on pre-adjusted parameters. The AI estimates the appropriate inquiry destination by emphasizing the profile information for a specific period based on the embedded representation of the default prompt. The AI outputs information indicating the appropriate inquiry destination corresponding to the calculated embedded representation. The estimation module 103 acquires the information indicating the appropriate inquiry destination output from the AI.

For example, there may be a case in which a certain another user used to be in the sales department and was knowledgeable about sales, but recently transferred to the development department and has become knowledgeable about websites. In this case, the old profile information on the certain another user indicates that the certain another user is knowledgeable about sales. The recent profile information on the certain another user indicates that the certain another user is knowledgeable about websites. When the inquiry information indicates an inquiry relating to HTML in relation to a website, the AI estimates that the certain another user is an appropriate inquiry destination from the embedded representation of the recent profile information on the certain another user. The estimation module 103 acquires information indicating the certain another user estimated by the AI. The processing after the appropriate inquiry destination is estimated may be the same as that of the at least one embodiment.

The estimation system 1 according to Modification Example 1 acquires profile information relating to the profile of each of the plurality of inquiry destinations for each of a plurality of periods. The estimation system 1 causes the AI to estimate the appropriate inquiry destination based on the profile information relating to the profile of each of the plurality of inquiry destinations for each of the plurality of periods. As a result, the estimation system 1 can cause the AI to estimate the appropriate inquiry destination based on the profile information for each period, thereby increasing the estimation accuracy of the AI. For example, when the default prompt indicates that recent profile information is to be emphasized, the estimation system 1 can cause the AI to estimate the appropriate inquiry destination based on recent trends.

### 6-2. Modification Example 2

For example, in Modification Example 1, the case in which profile information is prepared for each period has been taken as an example, but conversely, the profile information acquisition module 102 may acquire profile information that is not dependent on a period (period-independent profile information). "Period-independent profile information" is profile information that is not prepared for each period. One piece of period-independent profile information exists for one inquiry destination.

The profile information acquisition module 102 in Modification Example 2 acquires the one piece of profile information prepared for all the past periods. The period-independent profile information indicates a general profile. For example, the period-independent profile information may indicate a hobby or the lifework of the user. The profile information described in the at least one embodiment is not prepared for each period, and thus is also an example of period-independent profile information.

The estimation module 103 in Modification Example 2 causes the AI to estimate the appropriate inquiry destination based on the period-independent profile information. Modification Example 2 is different from the at least one embodiment and Modification Example 1 in that the profile information does not depend on the period, but the processing after the period-independent profile information and the like are input to the AI may be the same as that of the at least one embodiment and Modification Example 1. The AI calculates the embedded representation of the period-independent profile information and the like, and outputs information indicating the appropriate inquiry destination corresponding to the embedded representation. The processing after the appropriate inquiry destination is estimated may be the same as that of the at least one embodiment.

The estimation system 1 according to Modification Example 2 acquires period-independent profile information. The estimation system 1 causes the AI to estimate the appropriate inquiry destination based on the period-independent profile information. As a result, the estimation system 1 can cause the AI to estimate the appropriate inquiry destination based on the period-independent profile information, thereby increasing the estimation accuracy of the AI. For example, the estimation system 1 can cause the AI to estimate the appropriate inquiry destination corresponding to general profile information such as a hobby or the lifework of another user.

### 6-3. Modification Example 3

For example, there may be a plurality of types of inquiry destinations, such as other users, communication places, organizations, departments, and teams. The type of the inquiry destination can also be said to be a classification or an attribute of the inquiry destination. In Modification Example 3, a case in which, as the plurality of types of inquiry destinations, there are two types, namely, other users and communication places, is taken as an example. There may be three or more types of inquiry destinations.

The profile information acquisition module 102 in Modification Example 3 acquires the profile information relating to the profile of each of the plurality of inquiry destinations of the plurality of types. There are a plurality of inquiry destinations for each type of inquiry destination. For example, a plurality of employees of a certain company exist as inquiry destinations of the type "other user." A plurality of threads used by a certain company exist as inquiry destinations of the type "communication place." Similarly, for other types of inquiry destinations, a plurality of inquiry destinations exist for those types of inquiry destinations.

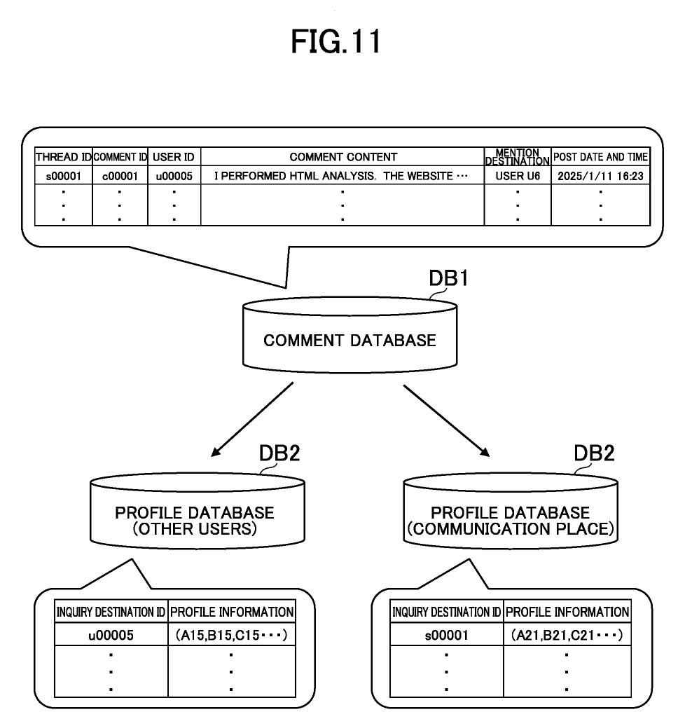

FIG. 11 is a table for showing an example of profile databases DB2 in Modification Example 3. As shown in FIG. 11, the data storage unit 100 in Modification Example 3 stores a profile database DB2 for each type of inquiry destination. In Modification Example 3, as the plurality of types of inquiry destinations, there are two types, namely, other users and communication places, and hence the data storage unit 100 stores a profile database DB2 in which profile information on other users is stored, and a profile database DB2 in which profile information on communication places is stored. The method of generating the profile database DB2 in which the profile information on other users is stored may be the same as that of the at least one embodiment.

For example, the server 10 generates, based on the comment database DB1, profile information on a certain communication place from the comments posted to the certain communication place, and stores the generated profile information in the profile database DB2. When the communication place is a thread, the server 10 generates profile information on each thread based on the comments posted to the thread, and stores the generated profile information in the profile database DB2. When the communication place is a space, the server 10 generates profile information on each space based on the comments posted in the space, and stores the generated profile information in the profile database DB2.

For example, the profile information acquisition module 102 acquires, from each of the plurality of types of profile databases DB2, the profile information on each of the plurality of inquiry destinations of those types. The profile information acquisition module 102 may acquire the profile information on each of the plurality of inquiry destinations of those types from another database, another computer other than the server 10, or an information storage medium. When an RAG mechanism is used as in the at least one embodiment, for each type, the profile information acquisition module 102 retrieves the inquiry information from the profile database DB2 of the type based on the inquiry information. The profile information acquisition module 102 acquires the profile information of the types retrieved from each of the plurality of types of profile databases DB2. The profile information may indicate what type of inquiry destination the profile information relates to.

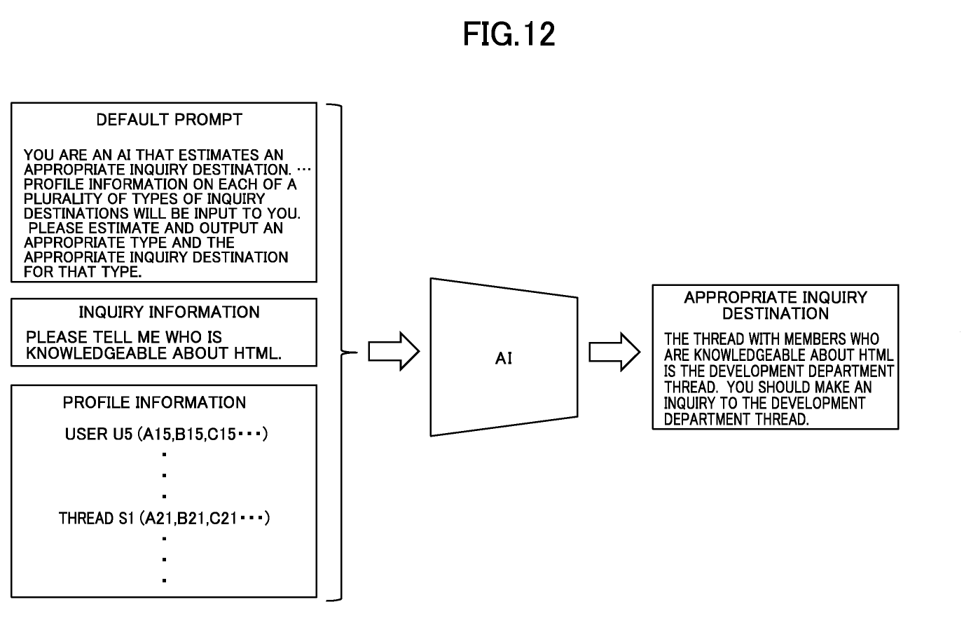

FIG. 12 is a diagram for illustrating an example of inputs to the AI and an output from the AI in Modification Example 3. As illustrated in FIG. 12, the default prompt in Modification Example 3 indicates that an appropriate type and the appropriate inquiry destination for that type are to be estimated based on profile information on each of a plurality of types of inquiry destinations. For example, the default prompt indicates a sentence such as "Profile information on each of a plurality of types of inquiry destinations will be input to you. Please estimate and output an appropriate type and the appropriate inquiry destination for that type." The default prompt may be another sentence. The default prompt may indicate what type of profile the profile information relates to.

The estimation module 103 in Modification Example 3 causes the AI to estimate the appropriate inquiry destination among the plurality of inquiry destinations of the plurality of types of inquiry destinations based on the profile information relating to the profile of each of the plurality of inquiry destinations of the plurality of types of inquiry destinations. For example, the estimation module 103 inputs the default prompt of FIG. 12, the inquiry information, and the profile information on each of the plurality of types of inquiry destinations to the AI. The AI calculates an embedded representation of those inputs based on pre-adjusted parameters. The AI estimates that a certain specific type of inquiry destination and a specific inquiry destination within that type are appropriate based on the embedded representation of the default prompt, and outputs information indicating the appropriate inquiry destination of the appropriate type corresponding to the calculated embedded representation. The estimation module 103 acquires the information indicating the appropriate inquiry destination of the appropriate type output from the AI. In the example of FIG. 12, the AI estimates that a certain specific thread is appropriate, instead of a certain specific other user. The processing after the appropriate inquiry destination is estimated may be the same that of the at least one embodiment.

The estimation system 1 according to Modification Example 3 acquires the profile information relating to the profile of each of the plurality of inquiry destinations of a plurality of types of inquiry destinations. The estimation system 1 causes the AI to estimate the appropriate inquiry destination among the plurality of inquiry destinations of a plurality of types of inquiry destinations based on the profile information relating to the profile of each of the plurality of inquiry destinations of a plurality of types of inquiry destinations. As a result, the user can know the appropriate inquiry destination of the appropriate type, and hence the estimation system 1 can increase the convenience of the user. For example, depending on the content of an inquiry, it may be more appropriate for the user to make the inquiry to a certain thread instead of to another user. In this case, the AI estimates a specific thread instead of another user, and hence the user can know that the specific thread is the appropriate inquiry destination.

### 6-4. Modification Example 4

For example, in the at least one embodiment and Modification Examples 1 to 3, the case in which the profile information on the inquiry destination is input to the AI has been taken as an example. The information input to the AI is not limited to the examples of the at least one embodiment and Modification Examples 1 to 3. In Modification Example 4, a case in which the profile information on the user who inputs the inquiry is input to the AI is taken as an example.

The estimation system 1 according to Modification Example 4 includes the user profile information acquisition module 104. The user profile information acquisition module 104 acquires user profile information on a profile of the user. The user profile information is profile information on the user who has input the inquiry. The user profile information is different from the profile information on the other users described in the at least one embodiment and Modification Examples 1 to 3 in that the user profile information is profile information on the user who has input the inquiry, but the content indicated by the profile information may be the same as that described in the at least one embodiment and Modification Examples 1 to 3. In the following description, when simply "profile information" is mentioned, that term refers to the profile information on another user other than the user who has input the inquiry.

In Modification Example 4, the user profile information is stored in the profile database DB2, and hence the user profile information acquisition module 104 acquires the user profile information from the profile database DB2. The user profile information may be stored in another database other than the profile database DB2, another computer other than the server 10, or an information storage medium. The user profile information acquisition module 104 may acquire the user profile information from the another database, the another computer, or the information storage medium.

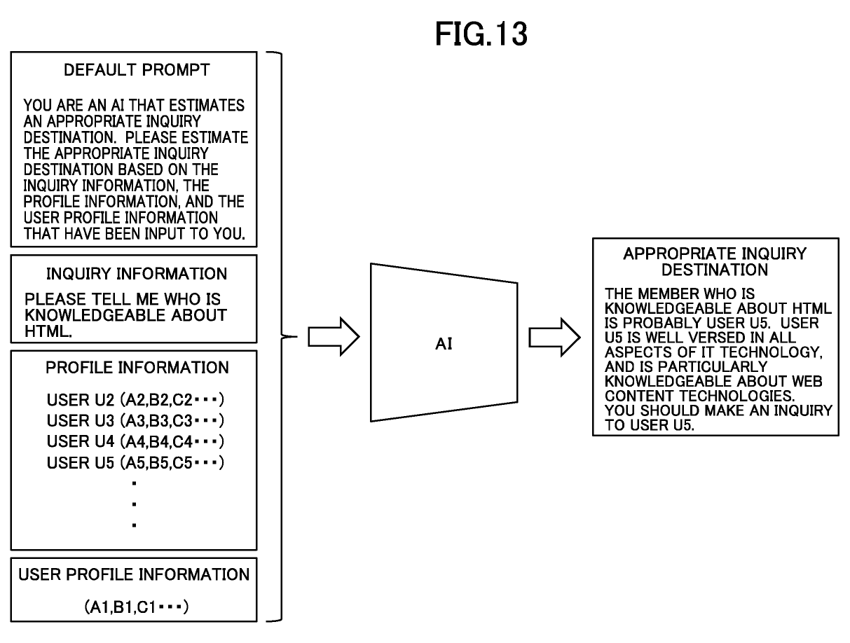

FIG. 13 is a diagram for illustrating an example of inputs to the AI and an output from the AI in Modification Example 4. As illustrated in FIG. 13, the default prompt in Modification Example 4 includes a sentence in natural language indicating that an appropriate inquiry destination is to be estimated based on inquiry information, the profile information, and user profile information. For example, the default prompt may indicate a sentence such as "You are an AI that estimates an appropriate inquiry destination. Please estimate the appropriate inquiry destination based on the inquiry information, profile information, and user profile information that have been input to you." The default prompt may be another sentence.

The estimation module 103 in Modification Example 4 causes the AI to estimate the appropriate inquiry destination further based on the user profile information. For example, the estimation module 103 inputs the default prompt, the inquiry information, the profile information, and the user profile information to the AI. The AI calculates an embedded representation of those inputs based on pre-adjusted parameters. The AI may divide those inputs into units called tokens, and calculate an embedded representation for each token. The AI outputs information indicating the appropriate inquiry destination corresponding to the embedded representations. The AI can estimate the appropriate inquiry destination corresponding to not only the inquiry information and the profile information, but also the user profile information, based on the embedded representation of the default prompt. The estimation module 103 acquires the information indicating the appropriate inquiry destination output from the AI. The processing after the appropriate inquiry destination is estimated may be the same as that of the at least one embodiment.

The estimation system 1 according to Modification Example 4 acquires user profile information. The estimation system 1 causes the AI to estimate the appropriate inquiry destination further based on the user profile information. As a result, the estimation system 1 can cause the AI to estimate the appropriate inquiry destination corresponding to the user who has input the inquiry, thereby increasing the estimation accuracy of the AI. For example, even for the same inquiry, the appropriate inquiry destination may differ depending on the user. In the case of an HTML inquiry such as that illustrated in FIG. 13, the user profile information indicates information on whether the user who has made the inquiry has some knowledge of HTML or no knowledge of HTML at all, and hence in such cases, the AI can estimate the appropriate inquiry destination corresponding to the user who has made the inquiry.

### 6-5. Modification Example 5

For example, as described somewhat in the at least one embodiment, the estimation module 103 may cause the AI to estimate an appropriate mention destination as the appropriate inquiry destination. The mention destination is not limited to the other users described in the at least one embodiment. The mention destination may be a group instead of an individual. For example, the mention destination may be an organization, a department, a team, a mailing list, participants in an online chat room, or another group. In Modification Example 5, it is assumed that the profile information on those mention destination candidates is stored in the profile database DB2.

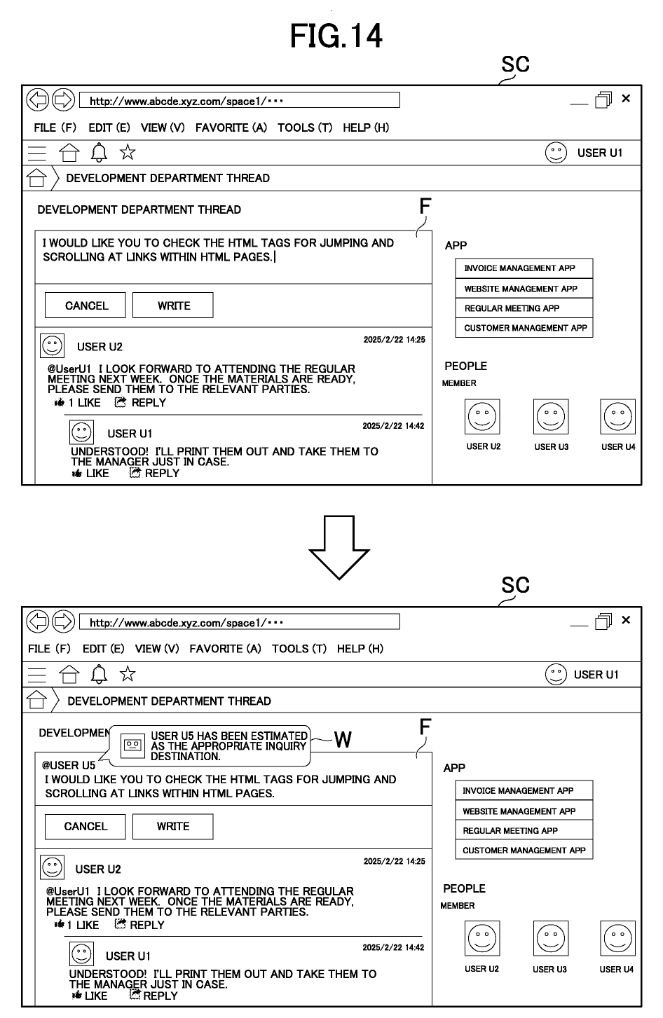

FIG. 14 is a view for illustrating an example of the work support screen SC in Modification Example 5. As illustrated in the upper part of FIG. 14, when the user inputs an inquiry into the input form F, the estimation module 103 causes the AI to estimate a mention destination. It is assumed that the default prompt in Modification Example 5 indicates that the appropriate mention destination is to be estimated based on the inquiry information and the profile information. The AI calculates an embedded representation of each of the default prompt, the inquiry information, and the profile information, and estimates the mention destination corresponding to those embedded representations.

For example, as illustrated in the lower part of FIG. 14, the estimation module 103 displays the mention destination estimated by the AI on the work support screen SC. In the example of FIG. 14, as in the at least one embodiment, the user U5 is estimated as the appropriate inquiry destination, and hence the estimation module 103 places the character string "user U5" estimated as the appropriate inquiry destination after the mention symbol "@," and displays "@user U5" in the input form F. The user may complete input of the inquiry as it is, or may change or delete the mention destination when the user thinks that the mention destination estimated by the AI is not appropriate. In the example of FIG. 14, the estimation module 103 also displays a window W indicating that the AI has estimated the appropriate mention destination.

The estimation system 1 according to Modification Example 5 includes the mention execution module 105. When the user has completed input of the inquiry under a state in which the appropriate mention destination is designated, the mention execution module 105 executes the mention to the appropriate mention destination. For example, the mention execution module 105 executes the mention by transmitting a predetermined notification to the mention destination estimated by the AI. The notification may be transmitted by any notification means. For example, the mention execution module 105 may execute the mention based on email, a notification function in the work support service, a notification function of the user terminal 20, or another notification means.

The estimation system 1 according to Modification Example 5 causes the AI to estimate an appropriate mention destination as the appropriate inquiry destination. When the user has completed input of the inquiry under a state in which the appropriate mention destination is designated, the estimation system 1 executes the mention to the appropriate mention destination. As a result, the user can know the appropriate mention destination, and hence the estimation system 1 can increase the convenience of the user.

### 6-6. Modification Example 6

For example, in Modification Example 5, the case in which the appropriate mention destination estimated by the AI is presented in a manner that is recognizable by the user has been described, but the appropriate mention destination estimated by the AI may be presented in a manner in which the user does not recognize the appropriate mention destination. In Modification Example 6, it is assumed that the mention destination is estimated in the same manner as that of Modification Example 5.

The estimation system 1 according to Modification Example 6 includes the mention destination presentation module 106. The mention destination presentation module 106 presents the appropriate mention destination to the user in a manner in which the user does not recognize the appropriate mention destination. "Manner in which the user does not recognize the appropriate mention destination" means that the mention does not include information (for example, characters, numerals, other symbols, images such as icons, or a combination of those) indicating the appropriate mention destination estimated by the AI. In the example of the lower part of FIG. 14, a manner in which the mention does not include information on the mention destination, such as "user U5," corresponds to a manner in which the user does not recognize the appropriate mention destination.

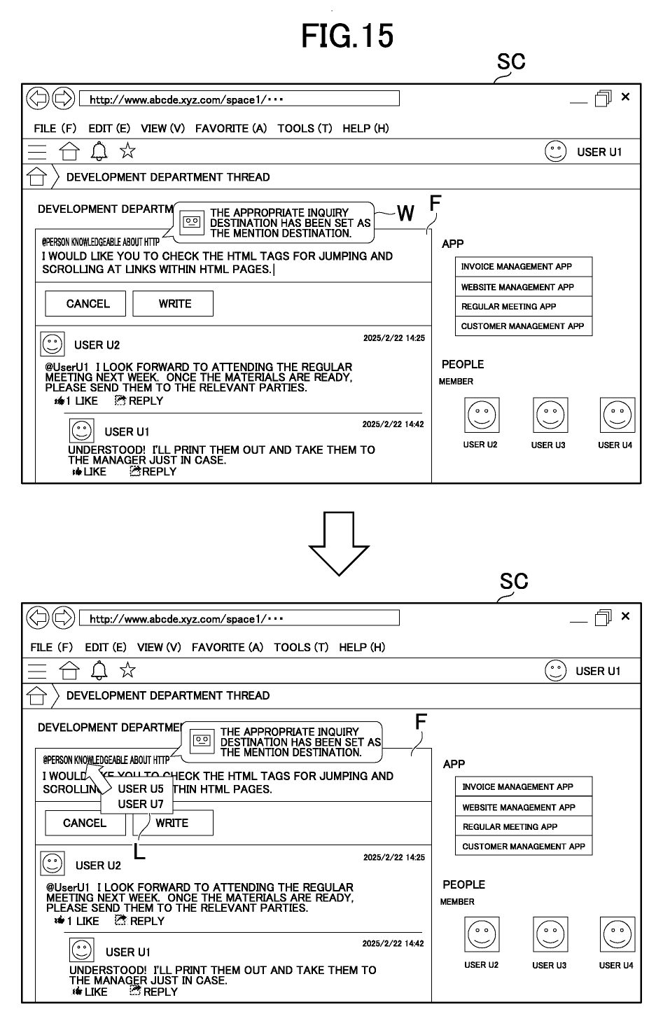

FIG. 15 is a view for illustrating an example of the work support screen SC in Modification Example 6. As illustrated in the upper part of FIG. 15, the mention destination presentation module 106 presents the appropriate mention destination to the user in a manner in which the user does not recognize the appropriate mention destination by placing the string "person knowledgeable about HTTP" in response to the inquiry input by the user after the mention symbol "@" instead of the name of another user estimated by the AI. As in Modification Example 5, the work support screen SC is displayed based on the assumption that the user U5 is estimated as the appropriate inquiry destination. The user does not recognize the specific mention destination from the character string "person knowledgeable about HTTP." This character string may be estimated by the AI or input by the user.

As illustrated in the lower part of FIG. 15, when the user focuses the mouse cursor on the character string "person knowledgeable about HTTP" of the mention destination, the mention destination presentation module 106 may present the appropriate mention destination to the user in a manner in which the user recognizes the appropriate mention destination. In the example of FIG. 15, the mention destination presentation module 106 displays a list L showing mention destinations estimated by the AI on the user terminal 20. For example, the user may delete or change the mention destinations displayed in the list L. The mention destination presentation module 106 may again present the list L after the user has deleted or changed those mention destinations. Information on the mention destinations deleted or changed by the user may be stored in the data storage unit 100.

After the appropriate mention destination has been presented to the user in a manner in which the user does not recognize the mention destination, the mention execution module 105 in Modification Example 6 executes the mention to the appropriate mention destination when the user has completed input of the inquiry under a state in which the appropriate mention destination is designated. Modification Example 6 is different from Modification Example 5 in that the appropriate mention destination is presented to the user in a manner in which the user does not recognize the appropriate mention destination, but the method of executing the mention after the user completes input of the inquiry is the same as that of Modification Example 5.

The estimation system 1 corresponding to Modification Example 6 presents the appropriate mention destination to the user in a manner in which the user does not recognize the appropriate mention destination. The estimation system 1 executes, after the appropriate mention destination has been presented to the user in a manner in which the user does not recognize the appropriate mention destination, the mention to the appropriate mention destination when the user has completed input of the inquiry under a state in which the appropriate mention destination is designated. As a result, the user can complete input of the inquiry without being aware of the details of the appropriate mention destination, and hence the estimation system 1 can increase the convenience of the user.

### 6-7. Modification Example 7

For example, as described somewhat in Modification Example 5, the appropriate mention destination estimated by the AI may be presented under a state that is recognizable by the user. The estimation system 1 according to Modification Example 7 includes the mention destination presentation module 106. The mention destination presentation module 106 presents the appropriate mention destination to the user before the user completes input of the inquiry. "Completes input of the inquiry" means performing an operation to post the inquiry.

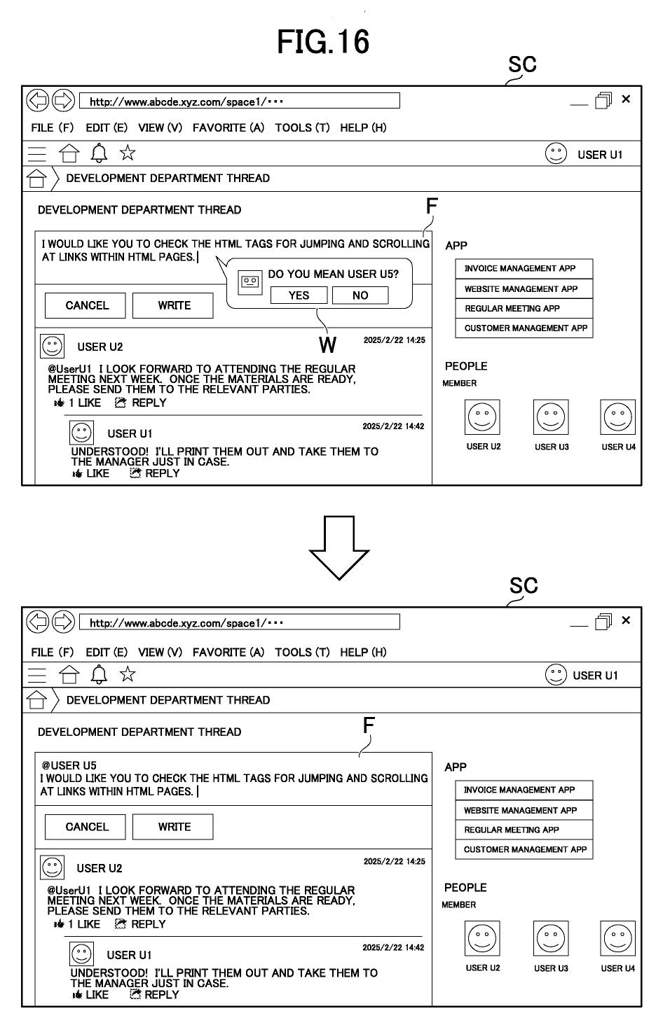

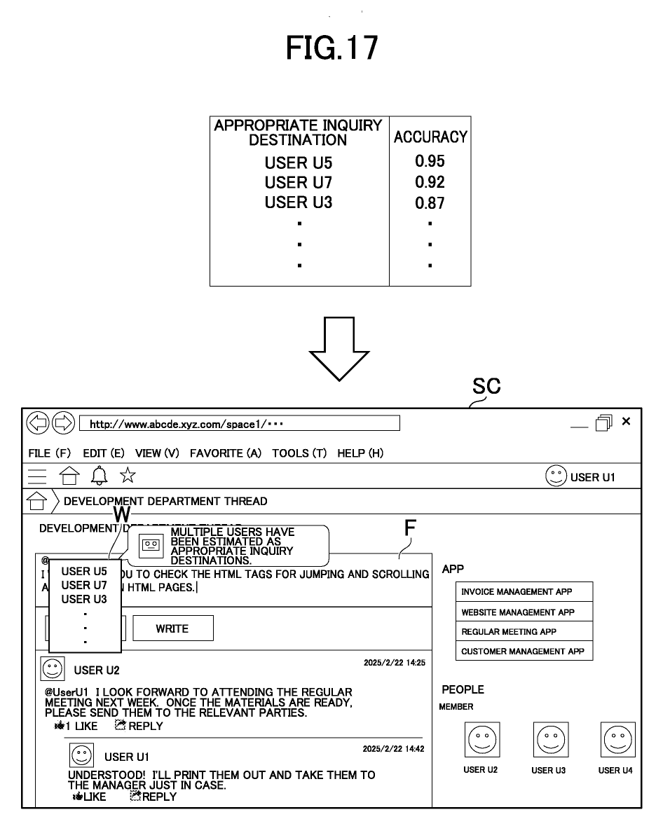

FIG. 16 is a view for illustrating an example of the work support screen SC in Modification Example 7. In the example of the upper part of FIG. 16, the mention destination presentation module 106 presents the appropriate inquiry destination estimated by the AI by displaying the appropriate inquiry destination in the window W when the user inputs an inquiry but before the user completes input of the inquiry. When the user performs an operation to set the appropriate inquiry destination displayed in the window W as the mention destination (for example, by selecting "Yes" in the window W of FIG. 16), the user terminal 20 sets the appropriate inquiry destination estimated by the AI as the mention destination, as illustrated in the lower part of FIG. 16. The mention destination presentation module 106 may present the appropriate inquiry destination by another method other than that of FIG. 16. For example, the mention destination presentation module 106 may display the appropriate inquiry destination in a list L as illustrated in FIG. 17.

After the appropriate mention destination has been presented to the user, the mention execution module 105 in Modification Example 7 executes the mention to the appropriate mention destination when the user has completed input of the inquiry under a state in which the appropriate mention destination is designated. Modification Example 7 is different from Modification Example 5 in that the appropriate mention destination is designated after the appropriate mention destination has been presented to the user, but the method of executing the mention after the user has completed input of the inquiry is the same as that of Modification Example 5.

The estimation system 1 according to Modification Example 7 presents the appropriate mention destination to the user before the user completes input of the inquiry. The estimation system 1 executes, after the appropriate mention destination has been presented to the user, the mention to the appropriate mention destination when the user has completed input of the inquiry under a state in which the appropriate mention destination is designated. As a result, the user can designate a mention destination and complete input of the inquiry after having grasped the appropriate mention destination, and hence the estimation system 1 can increase the convenience of the user.

### 6-8. Modification Example 8

For example, in Modification Example 7, the estimation module 103 may cause the AI to estimate a plurality of appropriate mention destinations. The default prompt in Modification Example 8 indicates that a plurality of appropriate mention destinations are to be estimated. The AI estimates the plurality of appropriate mention destinations based on an embedded representation of the default prompt. In Modification Example 8, an accuracy of the estimation result of each mention destination is calculated. The accuracy indicates the accuracy of the estimation by the AI of the appropriate inquiry destination. As used herein, "accuracy" may also be referred to as "likelihood" or "score." The accuracy can also be said to be the reliability of the estimation result of the appropriate inquiry destination by the AI.

The estimation system 1 according to Modification Example 8 includes the accuracy acquisition module 107. The accuracy acquisition module 107 acquires the accuracy of each of the plurality of appropriate mention destinations from the AI. The method of calculating the accuracy may be a publicly-known method. For example, the accuracy acquisition module 107 may acquire the accuracy of the AI estimation result based on a softmax function, a sigmoid function, temperature scaling, a Bayesian approach, distance in feature space, or another calculation method. In Modification Example 8, a case in which the accuracy is expressed numerically is taken as an example. For example, when the accuracy is higher, the reliability of the estimation result by the AI is higher, and when the accuracy is lower, the reliability of the estimation result by the AI is lower. The accuracy may be expressed as letters or other symbols.

FIG. 17 is a view for illustrating an example of the work support screen SC in Modification Example 8. The mention destination presentation module 106 in Modification Example 8 presents, when the user inputs a symbol relating to a mention, each of the plurality of appropriate mention destinations to the user based on the accuracy of each of the plurality of appropriate mention destinations. In the example of FIG. 17, the mention destination presentation module 106 displays, on the user terminal 20, a list L in which the plurality of appropriate mention destinations are sorted such that the plurality of appropriate mention destinations are arranged in descending order of the accuracy of each of the plurality of appropriate mention destinations.

The mention destination presentation module 106 may display, on the user terminal 20, a list L in which the plurality of appropriate mention destinations are sorted such that the plurality of appropriate mention destinations are arranged in ascending order of the accuracy of each of the plurality of appropriate mention destinations. The mention destination presentation module 106 may display, in the list L, among the plurality of appropriate mention destinations, only the mention destinations having an accuracy equal to or more than a threshold value. The mention destination presentation module 106 may display, in the list L, among the plurality of appropriate mention destinations, only the mention destinations having an accuracy equal to or higher than a predetermined rank. The mention destination presentation module 106 may display, in the list L, only the mention destinations having an accuracy that is equal to or more than a threshold value and, among those, that is equal to or higher than a predetermined rank (for example, mention destinations that have an accuracy of 80% or more and that are in the top 10 among the mention destinations having an accuracy of 80% or more).

The estimation system 1 according to Modification Example 8 causes the AI to estimate a plurality of appropriate mention destinations. The estimation system 1 acquires an accuracy of each of the plurality of appropriate mention destinations from the AI. The estimation system 1 presents, when the user inputs a symbol relating to a mention, each of the plurality of appropriate mention destinations to the user based on the accuracy of each of the plurality of appropriate mention destinations. As a result, the user can grasp the appropriate mention destination depending on the accuracy, and hence the estimation system 1 can increase the convenience of the user.

### 6-9. Modification Example 9

For example, when the inquiry destination is another user, from the perspective of the user, there is a possibility that new discoveries may be made or new information may be acquired when the AI estimates another user with whom the user does not normally communicate much. In view of this, the estimation module 103 may cause the AI to estimate another user with whom the user does not usually communicate much as an appropriate another user based on a prompt indicating that the AI is to estimate, among a plurality of other users, another user with whom the user does not communicate as an appropriate another user.

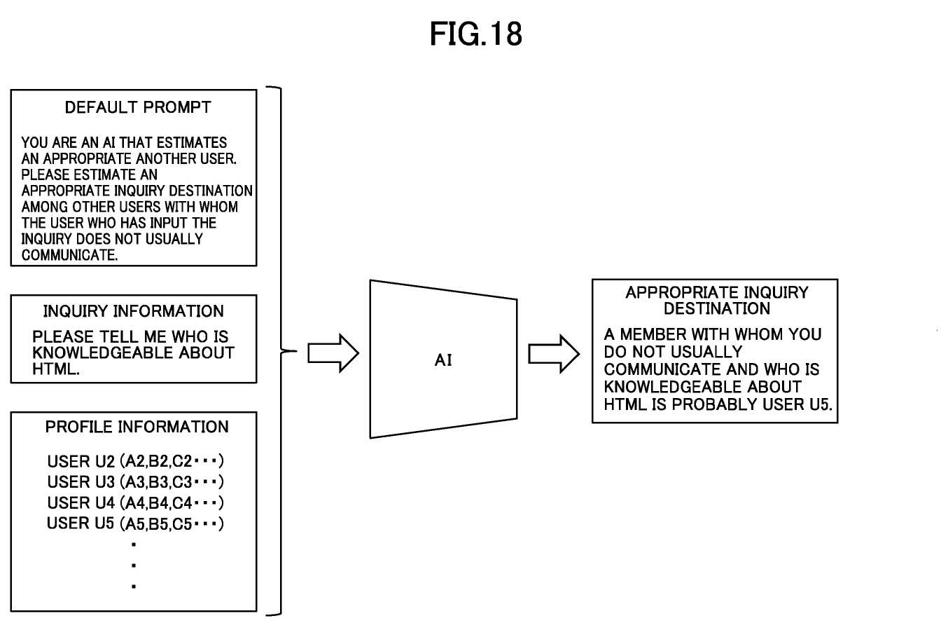

FIG. 18 is a diagram for illustrating an example of inputs to the AI and an output from the AI in Modification Example 9. As illustrated in FIG. 18, the default prompt in Modification Example 9 indicates that another user with whom the user does not communicate much is to be estimated. For example, the default prompt may indicate a sentence such as "You are an AI that estimates an appropriate another user. Please estimate the appropriate inquiry destination among other users with whom the user who has input the inquiry does not usually communicate." The default prompt may be another sentence.

For example, when the default prompt, the inquiry information, and the profile information are input to the AI, the AI calculates an embedded representation of the default prompt, the inquiry information, and the profile information based on pre-adjusted parameters. The AI may divide those inputs into units called tokens, and calculate an embedded representation for each token. The AI outputs information indicating the appropriate inquiry destination corresponding to the embedded representations. The AI preferentially estimates another user with whom the user does not communicate much based on the embedded representation of the default prompt. The estimation module 103 acquires the information indicating the appropriate inquiry destination output from the AI. The processing after the appropriate inquiry destination is estimated may be the same as that of the at least one embodiment.

The estimation system 1 according to Modification Example 9 causes the AI to estimate an appropriate another user based on a prompt indicating that, among a plurality of other users, another user with whom the user does not communicate is to be estimated as the appropriate another user. As a result, another user with whom the user does not communicate much can be estimated as the appropriate another user, and hence the estimation system 1 can increase the convenience of the user.

### 6-10. Other Modification Examples

For example, two or more of the modification examples described above may be combined.

For example, the case in which the estimation system 1 is applied to a work support service has been described, but the estimation system 1 may be applied to another service other than a work support service. When a user inputs an inquiry not in particular related to work (for example, an inquiry relating to a service the user uses in a private capacity), the estimation system 1 may cause the AI to estimate an appropriate inquiry destination. The inquiry information may indicate an inquiry not related to work. The profile information may indicate a profile not related to work.

For example, the functions described as being implemented by the server 10 may be implemented by the user terminal 20. In this case, it suffices that the functions are implemented by a browser script or an application installed on the user terminal 20. For example, the respective functions may be distributed to a plurality of computers, or may be implemented by a single computer.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An estimation system, comprising at least one processor configured to:
acquire inquiry information relating to an inquiry input by a user;
acquire profile information relating to a profile of each of a plurality of inquiry destinations; and
cause an artificial intelligence (AI) which is a trained large language model to estimate an appropriate inquiry destination for the inquiry among the plurality of inquiry destinations based on the inquiry information and the profile information.

2. The estimation system according to claim 1, wherein the at least one processor is configured to:
acquire the inquiry information when the user who is using a work support service inputs an inquiry relating to work;
acquire the profile information which is based on the work support service; and
cause the AI to estimate the appropriate inquiry destination in the work support service.

3. The estimation system according to claim 1,
wherein the plurality of inquiry destinations are a plurality of other users different from the user, and
wherein the at least one processor is configured to:
acquire the profile information relating to the profile of each of the plurality of other users; and
cause the AI to estimate, among the plurality of other users, another user who is appropriate for the inquiry as the appropriate inquiry destination.

4. The estimation system according to claim 1, wherein the at least one processor is configured to:
acquire the profile information relating to the profile of each of the plurality of inquiry destinations for each of a plurality of periods; and
cause the AI to estimate the appropriate inquiry destination based on the profile information relating to the profile of each of the plurality of inquiry destinations for each of the plurality of periods.

5. The estimation system according to claim 1, wherein the at least one processor is configured to:
acquire period-independent profile information; and
cause the AI to estimate the appropriate inquiry destination based on the period-independent profile information.

6. The estimation system according to claim 1, wherein the at least one processor is configured to:
acquire the profile information relating to the profile of each of the plurality of inquiry destinations of a plurality of types of inquiry destinations; and
cause the AI to estimate the appropriate inquiry destination among the plurality of inquiry destinations of the plurality of types of inquiry destinations based on the profile information relating to the profile of each of the plurality of inquiry destinations of the plurality of types of inquiry destinations.

7. The estimation system according to claim 1, wherein the at least one processor is configured to:
acquire user profile information relating to a profile of the user; and
cause the AI to estimate the appropriate inquiry destination further based on the user profile information.

8. The estimation system according to claim 1, wherein the at least one processor is configured to:
cause the AI to estimate an appropriate mention destination as the appropriate inquiry destination; and
execute a mention to the appropriate mention destination when the user has completed input of the inquiry under a state in which the appropriate mention destination is designated.

9. The estimation system according to claim 8, wherein the at least one processor is configured to:
present the appropriate mention destination to the user in a manner in which the user does not recognize the appropriate mention destination; and
execute, after the appropriate mention destination has been presented to the user in a manner in which the user does not recognize the appropriate mention destination, the mention to the appropriate mention destination when the user has completed input of the inquiry under a state in which the appropriate mention destination is designated.

10. The estimation system according to claim 8, wherein the at least one processor is configured to:
present the appropriate mention destination to the user before the user completes input of the inquiry; and
execute, after the appropriate mention destination has been presented to the user, the mention to the appropriate mention destination when the user has completed input of the inquiry under a state in which the appropriate mention destination is designated.

11. The estimation system according to claim 10, wherein the at least one processor is configured to:
cause the AI to estimate a plurality of the appropriate mention destinations;
acquire, from the AI, an accuracy of each of the plurality of the appropriate mention destinations; and
present, when the user inputs a symbol relating to a mention, each of the plurality of the appropriate mention destinations to the user based on the accuracy of each of the plurality of the appropriate mention destinations.

12. The estimation system according to claim 3, wherein the at least one processor is configured to cause the AI to estimate the appropriate another user based on a prompt indicating that, among the plurality of other users, another user with whom the user does not communicate is to be estimated as the appropriate another user.

13. An estimation method, comprising:
acquiring inquiry information relating to an inquiry input by a user;
acquiring profile information relating to a profile of each of a plurality of inquiry destinations; and
causing an artificial intelligence (AI) which is a trained large language model to estimate an appropriate inquiry destination for the inquiry among the plurality of inquiry destinations based on the inquiry information and the profile information.

14. A non-transitory information storage medium having stored thereon a program for causing a computer to:
acquire inquiry information relating to an inquiry input by a user;
acquire profile information relating to a profile of each of a plurality of inquiry destinations; and
cause an artificial intelligence (AI) which is a trained large language model to estimate an appropriate inquiry destination for the inquiry among the plurality of inquiry destinations based on the inquiry information and the profile information.
